(19) United States
(12) Patent Application Publication
(10) Pub. No.: US 2026/0167762 A1
(43) Pub. Date: Jun. 18, 2026

(54) THERMAL INTERFACE MATERIALS HAVING A COMBINATION OF FILLERS AND REDUCED SQUEEZE FORCE

(71) Applicant: Dow Global Technologies LLC, Midland, MI (US)

(72) Inventor: Praveen Agarwal, Lake Jackson, TX (US)

(21) Appl. No.: 19/125,326

(22) PCT Filed: Oct. 30, 2023
(86) PCT No.: PCT/US2023/078174

§ 371 Date: Apr. 29, 2025

Related U.S. Application Data
(60) Provisional application No. 63/421,200, filed on Nov. 1, 2022.

(51) Int. Cl. C08G 18/76; C08G 18/10; C08G 18/48

(52) U.S. Cl. CPC C08G 18/7671; C08G 18/10; C08G 18/4812

(57) ABSTRACT

Thermally conductive composition may include a polymer matrix; and a polymodal filler composition at a percent by weight (wt %) of the thermally conductive composition in a range of 60 wt % to 95 wt %, containing a first thermally conductive filler of aluminum trihydrate (ATH) having a D50 particle size in the range of 0.1 um to 10 um, a second thermally conductive filler of ATH having a D50 in the range of 10 um to 100 um, wherein the first thermally conductive filler and the second thermally conductive filler are present at a percent by weight of the polymodal filler composition (wt %) in a range of 40 wt % to 90 wt %; and a third thermally conductive filler of alumina having a D50 in the range of 5 um to 100 um at a percent by weight of 10 wt % to 60 wt %.

### FIELD

Embodiments relate to thermally conductive compositions for use as a gap filler, adhesive, sealant, or paste in applications requiring thermal management such as electronics and automotive applications, and methods for using same.

### INTRODUCTION

Thermal interface materials such as gap fillers and gels are used widely for thermal management in electronics and automotive applications. For example, electric vehicle (EV) batteries are cooled by mounting one or more battery modules to a cooling plate that redirects heat. For efficient cooling, consistent thermal contact between the battery modules and the cooling plate is needed, which often involves the use of thermal interface materials such as adhesives, sealants and gap fillers. Thermal gap pads and dispensable gap fillers are two of the primary gap filler technologies. Among the two, dispensable gap fillers have the advantage of providing more efficient heat transfer and less wastage of material compared to thermal pads that may require trimming and customization during installation. It is desired to have a thermal interface material composition with a high thermal conductivity (>1.0 W/m·K), ability to form a cured solid part with no applied heat, low density, and is easily processed. Another common challenge with thermal interface materials is the separation of matrix phase and the filler during storage. Thus, there is a need to develop thermal interface materials with high thermal conductivity, low viscosity, and storage stability.

### SUMMARY

In an aspect, thermally conductive compositions may include a polymer matrix; and a polymodal filler composition at a percent by weight (wt %) of the thermally conductive composition in a range of 60 wt % to 95 wt %, containing a first thermally conductive filler of aluminum trihydrate (ATH) having a D50 particle size in the range of 0.1 μm to 10 μm, a second thermally conductive filler of ATH having a D50 in the range of 10 μm to 100 μm, wherein the first thermally conductive filler and the second thermally conductive filler are present at a percent by weight of the polymodal filler composition (wt %) in a range of 40 wt % to 90 wt; and a third thermally conductive filler of alumina having a D50 in the range of 5 μm to 100 μm at a percent by weight of 10 wt % to 60 wt %.

In another aspect, methods of using a thermally conductive composition include: combining an isocyanate component including a blocked isocyanate prepolymer and an isocyanate-reactive component comprising one or more polyetheramines to form the thermally conductive composition, wherein the isocyanate component and/or the isocyanate-reactive component comprise a polymodal filler composition at a percent by weight (wt %) of the thermally conductive composition in a range of 60 wt % to 95 wt %, the polymodal filler composition comprising a first thermally conductive filler of aluminum trihydrate (ATH) having a D50 particle size in the range of 0.1 μm to 10 μm, a second thermally conductive filler of ATH having a D50 in the range of 10 μm to 100 μm, wherein the first thermally conductive filler and the second thermally conductive filler are present at a percent by weight of the polymodal filler composition (wt %) in a range of 40 wt % to 90 wt %; and a third thermally conductive filler of alumina having a D50 in the range of 5 μm to 100 μm at a percent by weight of 10 wt % to 60 wt %; and emplacing the thermally conductive composition between a heat source and a heat sink in an EV battery.

### DETAILED DESCRIPTION

Embodiments disclosed herein relate to thermally conductive compositions for use in thermal management applications, including the enhancing heat transmission in batteries, electronic devices, automotive applications, and the like. Thermally conductive compositions may include a polymer matrix having a polymodal filler composition dispersed therein. In an aspect, the polymer matrix may be generated from the reaction of an isocyanate component and an isocyanate-reactive component that are combined and applied in situ to cure at room temperature. Thermally conductive compositions disclosed herein may include a polymodal filler composition in the isocyanate component and/or the isocyanate-reactive component that improves thermal conductivity and reduces squeeze force during application. In some cases, thermally conductive compositions may be pre-cured and applied as a gap filler pad.

During the battery assembly process, gap filler compositions are applied to a substrate and battery modules are assembled (“squeezed”) onto the pre-dispensed gap filler.

Thermally conductive compositions disclosed herein may include a polymodal filler that enhances thermal conductivity and reduces the squeeze force during preparation and application. Reducing the viscosity and squeeze force of the components of the thermally conductive composition may be beneficial, for example, by reducing the force required to assemble a gap filler between a heat source and a heat sink, such as in an EV battery application.

The numerical ranges disclosed herein include all values from, and including, the lower and upper value and all values in between. Unless stated to the contrary, implicit from the context, or customary in the art, all parts and percentages are based on weight and all test methods are current as of the filing date of this disclosure.

As used herein, the term “average particle size” refers to the median particle size or diameter of a distribution of particles as determined for example, by a Multisizer 3 Coulter Counter (Beckman Coulter, Inc., Fullerton, CA) according to the procedure recommended by the manufacturer. The median particle size, D₅₀ is defined as the size wherein 50 cumulative % of the distribution is smaller than the stated value D₉₀ is defined as the size wherein 90 cumulative % of the distribution is smaller than the stated value. D₁₀ is defined as the size wherein 10 cumulative % of the distribution is smaller than the stated value. Particle size distribution can be determined by known methods in the art such as ASTM B822-10 or ASTM B822-20 or ISO 13320 using appropriate suspending medium or in dry state. The average particle size may be estimated based on measuring the surface area according to 8-11 ASTM D4315 or by using sieves of various mesh sizes and calculating the average from the cumulative weight of each size fractions. These alternative methods give estimations of the average particle sizes similar to those determined by the laser diffraction method. Span of the filler particle size distribution is defined as (D₉₀-D₁₀)/D₅₀, and is an indication of the width of the particle size distribution.

As disclosed herein, “room temperature” means a temperature range from 18° C. to 35° C.

As disclosed herein, “molecular weight” means number average molecular weight.

As disclosed herein, “thermally conductive filler” means a thermal conductivity value greater than 1 W/m·K as measured by ISO 22007-2 using hot disc or ASTM D-5470.

As disclosed herein, “thermally conductive composition” (which includes both cured and uncured compositions) means a composition having a thermal conductivity value greater than 1.0 W/m·K as measured by ISO 22007-2 using hot disc or ASTM D-5470.

As disclosed herein, “squeeze force” refers to resistance of a thermally conductive composition or component to compression, as measured in Newtons. Squeeze force is measured using a TA.XTplus texture analyzer equipped with a 50 kg load cell. After dispensing the respective sample onto a flat aluminum substrate, an acrylic probe with a diameter of 40 mm is lowered to sandwich the test material against the flat substrate to achieve a standard 5.0 mm gap thickness. Any excess overflow material was trimmed away with a flat-edge spatula. After trimming, the test started and the probe moved to a final thickness of 0.3 mm, at a rate of 1.0 mm/sec while the force was recorded. The specific force value recorded at the gap of 0.5 mm is reported as the “squeeze force”.

Viscosity can be measured using methods commonly known in the art using TA instruments ARES-G2, AR2000 type rheometers or Anton Paar MCR rheometers using parallel plate fixtures.

Thermally conductive compositions for use in thermal management applications, including the enhancing heat transmission in electronic devices, batteries, automotive applications, and the like. Described compositions can be used as a thermally conductive gap filler or a pre-cured thermal pad for applications requiring thermal management, such as electric vehicle batteries.

Thermally conductive compositions may include a polymer matrix having a polymodal filler composition dispersed therein. The polymeric matrix may be generated from any suitable polymeric material and may be solid, semi-solid, grease, or other form suitable for application and use as a gap filler. Suitable polymer matrices may be formed of elastomeric materials such as polyurethanes, polyureas, epoxy, acrylate, silicone, silane modified polymers (SMP), and the like. In one embodiment, polymer matrix is polyurethane.

In some cases, thermally conductive compositions disclosed herein generally include a polymer matrix obtained from combining a two-component curable composition: an isocyanate component (“A-side”) and an isocyanate-reactive component (“B-side”). During application, the A-side and B-side are mixed, initiating a curing reaction at room temperature, and forming the thermally conductive composition. Thermally conductive compositions may also include one or more thermally conductive fillers in the A-side and/or the B-side to enhance thermal transport properties.

### A.) Isocyanate Component

The isocyanate component (or A-side) may contain one or more blocked isocyanate prepolymers and other additives such as plasticizers and thermally conductive fillers.

### Blocked Isocyanate Prepolymer

The isocyanate component may include a blocked isocyanate prepolymer product generated by reacting an isocyanate terminated prepolymer (including any residual monomeric diisocyanate) and one or more blocking agents. Reaction with a blocking agent may limit the presence of free isocyanate (e.g., below a concentration of 0.1 wt %) and minimize premature gelation and crosslinking of the prepolymer. In some cases, reacting the isocyanate groups with a blocking agent will reduce the free isocyanate content in the prepolymer to less than 0.1 wt %, less than 0.01 wt %, less than 0.001 wt %, or zero wt %.

Isocyanate terminated prepolymers may be any prepolymer(s) prepared by the reaction of one or more polyols with a stoichiometric excess of one or more polyisocyanates containing two or more isocyanate groups. The polyisocyanates may be aromatic, aliphatic, araliphatic or cycloaliphatic polyisocyanates, or mixtures thereof. Suitable polyisocyanates include toluene diisocyanate (TDI), diphenylmethane diisocyanate (MDI), isophorone diisocyanate (IPDI), hexamethylene diisocyanate (HDI), tetramethylene-1,4-diisocyanate, cyclohexane-1,4-diisocyanate, hexahydrotolylene diisocyanate, 1-methoxyphenyl-2,4-diisocyanate, diphenylmethane-4,4′-diisocyanate, diphenylmethane-2,4′-diisocyanate, 4,4′-biphenylene diisocyanate, 3,3′-dimethoxy-4,4′-diphenyl diisocyanate, and 3,3′-dimethyldiphenylpropane-4,4′-diisocyanate; isomers thereof, or mixtures thereof. Suitable polyisocyanates may have an average isocyanate functionality of 1.9 or more, 2.0 or more, 2.1 or more, or 2.2 or more, and at the same time, 3.5 or less, 3.2 or less, 3.0 or less, or 2.8 or less. The isocyanate-terminated prepolymer may have an isocyanate (NCO) content by weight according to ASTM D5155-19 of 1% or more, 2.7% or more, or 5% or more, and at the same time, 30% or less, 25% or less, or 20% or less.

The isocyanates used to prepare the isocyanate terminated prepolymers can include the above stated monomeric polyisocyanates, isomers thereof, polymeric derivatives thereof, or mixtures thereof. In some cases, isocyanates may include toluene diisocyanate (TDI), polymeric derivatives thereof, or mixtures thereof. TDI used to prepare the isocyanate terminated prepolymer may be 2,4-isomer and the 2,6-isomer of toluene diisocyanate among others. Toluene diisocyanate based prepolymers may result in lower deblocking temperatures along with high conversion and reaction rates. Mixtures of two or more polyisocyanates may also be used.

The polyols and polyol mixtures used to prepare the isocyanate terminated prepolymer may include ethylene glycol, 1,2-propanediol, 1,3-propanediol, neopentylglycol, bis(hydroxy-methyl)cyclohexanes such as 1,4-bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, polyether polyols, and the like. The isocyanate terminated prepolymer may be prepared by procedures such as those described in U.S. Pat. Nos. 4,294,951; 4,555,562; and 4,182,825; and International Publication No. WO 2004/074343. Isocyanate prepolymers and/or blocked isocyanate prepolymers may be formed using a catalyst in some embodiments, which may include amine-based catalysts and/or tin-based catalysts.

The blocked isocyanate prepolymer, in some embodiments, may be formed by mixing and reacting one or more of the isocyanate functionalities on an isocyanate prepolymer with one or more blocking agents. Blocking agents for reaction with the isocyanate terminated prepolymer may include monophenolics; alkyl phenols such as nonylphenol; or alkenyl phenols such as cardanol or mixtures, such as cashew nutshell liquid, and the like, and derivatives and mixtures of any thereof. The blocking agent may be used in an amount such that the equivalents of the functional groups of the blocking agent correspond to the amount of isocyanate groups to be blocked, in molar or excess equivalents. In some embodiments, the blocked isocyanate prepolymer is made from TDI using a PO polyol of number average equivalent weight of 500 to 2500 Da and functionality 1.9 to 3.1, with 2% to 15% NCO before blocking with a blocking agent such as cardanol.

The isocyanate component may include a blocked isocyanate prepolymer at a percent by weight (wt %) of 0.5 wt % to 10 wt %, 1 wt % to 8 wt %, or 1 wt % to 5 wt %. Blocked isocyanate prepolymer compositions may include a thermally conductive filler present at a percent by weight (wt %) of 50 wt % to 95 wt %, 75 wt % to 94 wt %, or 80 wt % to 92 wt %.

### B.) Isocyanate-Reactive Component

The isocyanate-reactive component (or B-side) may contain of one or more isocyanate-reactive species containing one or more functional groups such as hydroxyls or amines, and one or more additives such as plasticizers and thermally conductive fillers.

### Polyether Amines

The isocyanate-reactive component may include one or more polyetheramines. Polyetheramines may include monoamines, diamines, and higher order amines (e.g., triamines, tetramines, etc.). In some cases, the isocyanate-reactive components may include a mixture of high and low molecular weight polyetheramines, such as one or more polyetheramines having a molecular weight of 2000 or more (high MW), and one or more polyetheramines having a molecular weight of 2000 or less (low MW). High MW polyetheramines and low MW polyetheramines may independently be selected from polyetheramines having an amine functionality in the range of 1.5 to 4, 2 to 4, or 2.5 to 3.5. The molar ratio of high MW: low MW polyetheramines may be in the range of 10:1 to 1:10, 5:1 to 1:5, or 3:1 to 1:3.

Suitable polyetheramines include resins made from an appropriate initiator to which lower alkylene oxides, such as ethylene oxide, propylene oxide, butylene oxide or mixtures thereof are added, with the resulting hydroxyl-terminated polyol then being aminated. When two or more oxides are used, they may be present as random mixtures or as blocks of one or the other polyether. In the amination step, the terminal hydroxyl groups in the polyol may be primary or secondary hydroxyl groups. Reductive amination processes are known and described in U.S. Pat. No. 3,654,370. Polyetheramines may include commercially available amines such as primary aliphatic JEFFAMINE™ series of polyether amines available from Huntsman Corporation; including JEFFAMINE™ T-403, JEFFAMINE™ T-3000 and JEFFAMINE™ T-5000; or available from BASF including Baxxodur™ EC 3003, and Baxxodur™ EC 311.

In some embodiments, the isocyanate-reactive component may include at least one polyetheramine present at a percent by weight of the isocyanate-reactive component (wt %) from 0.2 wt % to 10 wt %, 0.5 wt % to 8 wt %, or 0.5 wt % to 7 wt %. In formulations containing mixtures of high MW and low MW polyetheramines, wt % ranges may be applied to each type of polyetheramine independently or as a combined total. Isocyanate-reactive components may include a thermally conductive filler present at a percent by weight (wt %) of 50 wt % to 95 wt %, 75 wt % to 94 wt %, or 80 wt % to 92 wt %.

A plasticizer may be mixed into either or the blocked isocyanate component or the amine component in an amount of from 0 to 20 wt. %, or from 2 to 12 wt. % or from 4 to 10 wt. %, based on the total weight of the two-component composition. Suitable plasticizers may be any common plasticizers useful in polyurethane and well known to those skilled in the art. The plasticizer may be present in an amount sufficient to disperse the prepolymer/amine or to reduce the viscosity of the composition. One example of a suitable plasticizer may be a methyl ester derivative of soybean oil. Other plasticizers such as phthalates, 2,2,4-Trimethyl-1,3-pentanediol diisobutyrate (TXIB); or, terephthalates may also be used. Yet other useful plasticizers may include glycol ether esters, partially hydrogenated terpenes commercially available as “HB-40” (Eastman, Kingsport, TN), chloroparaffins, alkyl naphthalenes, and the like.

Thermally conductive compositions may include a dispersion additive in the B-side that stabilizes the filler and other components in at least one of the blocked isocyanate prepolymer composition or the amine composition. Dispersion additives function to stabilize the particle via either steric, electrosteric, or electrostatic means and can be non-ionic, anionic, cationic, or zwitterionic. Structures can be linear polymers and copolymers, head-tail type modified polymers and copolymers, AB-block copolymers, ABA block copolymers, branched block copolymers, gradient copolymers, branched gradient copolymers, hyperbranched polymers and copolymers including hyperbranched polyesters and copolymers, star polymers and copolymers. BASF, Lubrizol, RT Vanderbilt, and BYK are all common manufacturers of dispersants. Trade names include: Lubrizol Solsperse series, series, Vanderbilt Darvan BASF Dispex series BYK DisperByk series, BYK LP-C 2XXXX series. Grades can include BYK DisperByk 162, 181, 182, 190, 193, 2200, and 2152; LP-C 22091, 22092, 22116, 22118, 22120, 22121, 22124, 22125, 22126, 22131, 22134, 22136, 22141, 22146, 22147, 22435; LP-N 22269; Solsperse 3000, and Darvan C—N.

In some embodiments, the dispersion additive is a hyperbranched polyester containing amine groups sterically protected by polyester side chains. Dispersion additives disclosed herein may be present in amount of 0.01 wt % to 2 wt %, 0.1 wt % to 1 wt %, or 0.1 wt % to 0.5 wt % in B-side of the composition.

### Polymodal Filler Composition

Thermally conductive compositions may also include one or more thermally conductive fillers in the A-side and/or the B-side that generate a polymodal filler composition when combined.

Thermally conductive fillers disclosed herein may include one or more of aluminum trihydrate (ATH), natural or synthetic aluminum oxide (alumina), and the like. Polymodal filler compositions may include one or more filler types and having three or more modes characterized by local maxima. Polymodal filler compositions may include a first thermally conductive filler of ATH having a D50 particle size in the range of 0.1 μm to 10 μm, a second thermally conductive filler of ATH having a D50 in the range of 10 μm to 100 μm, wherein the first thermally conductive filler and the second thermally conductive filler are present at a percent by weight of the polymodal filler composition (wt %) in a range of 40 wt % to 90 wt %; and a third thermally conductive filler of alumina having a D50 in the range of 5 μm to 100 μm at a percent by weight of 10 wt % to 60 wt %.

In some cases, the first thermally conductive filler and second thermally conductive filler may be provided as a subcombination prior to mixture with the third thermally conductive filler and/or into the thermally conductive composition. The subcombination may be generated by combination of separate fractions, removal of intervening fractions, such as a screen or particle sizer, or through various grinding and sizing techniques. The subcombination may also be modified by various treating agent prior to combination with the third thermally conductive filler and/or into the thermally conductive composition. Subcombination of first and second thermally conductive filler may have particle size distributions characterized span as (D90-D10)/D50) of greater than 2, greater than 3, or greater than 4, or less than 10.

In one embodiment, the subcombination of first and second thermally conductive filler is ATH with D₁₀ in the range of 0.1 to 10 microns, D₅₀ in the range of 5 to 50 microns, and D₉₀ in the range of 50 to 200 microns. Thermally conductive fillers may also be pre-treated with a C5-C20 silane treating agent to modify hydrophobicity and compatibility with the isocyanate component and/or the isocyanate-reactive component and to reduce the viscosity/squeeze force.

Polymodal filler compositions may include a mixture of ATH and alumina particles in which two or more of the modes are ATH or alumina. In a particular example, polymodal filler compositions may include a first thermally conductive filler of ATH having a D50 particle size in the range of 0.1 μm to 10 μm, a second thermally conductive filler of ATH having a D50 in the range of 10 μm to 100 μm, wherein the first thermally conductive filler and the second thermally conductive filler are present at a percent by weight of the polymodal filler composition (wt %) in a range of 40 wt % to 90 wt %; and a third thermally conductive filler of alumina having a D50 in the range of 5 μm to 100 μm at a percent by weight of 10 wt % to 60 wt %.

Polymodal filler compositions may include a mixture of ATH fillers and alumina fillers, such as those described above, in which ATH filler is present at a percent by weight (wt %) of the polymodal filler composition at least 35 wt %, at least 40 wt %, or at least 45 wt %. In some cases, the polymodal filler composition may include a bimodal ATH composition (which may be surface modified) that is combined with an alumina third thermally conductive filler and/or into the thermally conductive composition. The thermally conductive fillers of the present disclosure can be modified with a treating agent before incorporation in the A-side and/or B-side of a thermally conductive composition. In some cases, modification of a thermally conductive filler prior to addition to an A-side and/or B-side component can reduce viscosity or squeeze force of the composition, in addition to improving storage stability and handling.

Treating agents disclosed herein may be used to alter the hydrophobicity/hydrophilicity of the surface of a thermally conductive filler, improving filler and polymer interaction, and modify the viscosity and squeeze force of the resulting thermally conductive composition. For example, a filler may be reacted with a treating agent such as silane (a process also called silanization), which may increase the compatibility of the filler with the isocyanate component and/or isocyanate-reactive component. In some cases, one or more of the first, second, or third thermally conductive fillers are hydrophobically modified with a treating agent.

Suitable treating agents may include fatty acids, silane treating agents, titanates, zirconates, aluminates, or silazane compounds. In some embodiments, silane treating agents may contain at least one alkoxy group to facilitate surface treatment and/or chemical bonding to the filler. Silane treating agents may also include another group including for example alkyl, hydroxyl, vinyl, allyl, hydrosilyl (i.e., SiH), or other functionalities that can react with the formulation or be compatible or miscible with the formulation. Silane treating agents may have a chemical structure of Si(OR)ₙ(R′)₄₋ₙ, where n is an integer from 1 to 3, R is independently a C1 to C3 alkyl group, and R′ is independently an alkyl group from C1 to C20 with at least one R′ being chosen from C5 to C20.

Treating agents may be applied to the filler as a pre-treatment prior to introduction into the A-side and/or B-side. The concentration may vary depending on the nature of the treating agent and the thermally conductive filler type. Treating agents disclosed herein may be added to a filler as a pre-treatment at a percent by weight of the filler (wt %) of 0.5 wt % to 10 wt %, 0.5 wt % to 7.5 wt %, or 0.5 wt % to 5 wt %.

Polymodal filler compositions disclosed herein may be present at a percent by weight of the total weight of the thermally conductive composition (wt %) of 40 wt % to 98 wt %, 50 wt % to 95 wt %, 60 wt % to 95 wt %, 75 wt % to 95 wt %, or 80 wt % to 95 wt %. The polymodal filler composition may be loaded in the A-side and/or B-side in equal or differing amounts that, when combined, result in a thermally conductive composition having a filler concentration within any of the above ranges.

Filler compositions disclosed herein may have a thermal conductivity of at least 1 W/m·K, at least 5 W/m·K, or at least 20 W/m·K, and may have a thermal conductivity of less than 1000 W/m·K, or less than 100 W/m·K. Fillers disclosed herein may have low density to reduce overall weight of the composition and reduce weight in automotive, EV, and other application areas. In one embodiment, the filler density is <6 μm/cc, <4 μm/cc, or <2.5 μm/cc, or greater than 1 gm/cc.

In some embodiments, one or more treating agents, such as a silane treating agent, may be added to the A-side and/or B-side to improve the storage stability. Silane treating agents disclosed herein may be present (irrespective of any present in or on the polymodal filler composition) at a percent by weight of the total weight of the thermally conductive composition (wt %) of 0.1 wt % to 10 wt %, 0.1 wt % to 7.5 wt %, or 0.1 wt % to 5 wt %.

### Catalysts

Thermally conductive compositions may include one or more catalysts mixed into at least one of the isocyanate component or the isocyanate-reactive component to promote the reaction of blocked isocyanate functional groups with the polyetheramines. The catalysts may be any one or any combination/mixture of more than one selected from carboxylate salts, tertiary amines, amidines, guanidines, and diazabicyclo compounds. Suitable catalysts include bismuth octoate, bismuth neodecanoate, potassium acetate, potassium 2-ethylhexanoate, or mixtures thereof. Catalysts may include sterically hindered tertiary amines; a long chain tertiary amines (i.e., amine substituents of at least 6 hydrocarbons); or a cyclic tertiary amines. Suitable tertiary amines include dimorpholinodialkyl ether, di((dialkylmorpholino)alkyl) ether such as (di-(2-(3,5-dimethyl-morpholino)ethyl) ether), triethylene diamine, N,N-dimethylcyclohexylamine, N,N-dimethyl piperazine, 4-methoxyethyl morpholine, N-methylmorpholine, N-ethyl morpholine, or mixtures thereof. In some embodiments, the amidine or guanidine are N-hydrocarbyl substituted amidines or guanidines; in a further embodiment the amidine or guanidine are cyclic amidines or cyclic guanidines. Suitable amidines or guanidines include 1,8-diazabicyclo[5.4.0]undec-7-ene (DBU), 1,5,7-triazabicyclo[4.4.0]dec-5-ene, diazabicyclo[5.4.0]undec-7-ene, and N-methyl-1,5,7-triazabicyclododecene. The catalyst may be present in the isocyanate-reactive component at a percent by weight (wt %) ranging from 0.001 wt % to 5.0 wt %, from 0.01 wt % to 2.0 wt %, or from 0.02 wt % to 0.5 wt %.

Thermally conductive compositions may also include one or more additives such as moisture scavengers (e.g., zeolites, molecular sieves, p-toluene sulfonylisocyanate), adhesion promoters, thixotropic agents, plasticizers, color agents such as dyes or pigments, antioxidants, wetting agents such as surfactants, filler dispersion agents, thickening agents, compatibilizers, anti-settling agents, anti-syneresis agents, flame retardants, and/or filler treatment agents such as silanes and BYK surface treatment additives.

### C. Method of Preparation

Thermally conductive compositions may be prepared by introducing a polymodal filler composition into a polymer matrix by any suitable method. For polyurea and polyurethane compositions, preparation of the thermally conductive compositions of the present disclosure may be achieved by mixing the respective components of the isocyanate component and the isocyanate-reactive component in any sequence and allowing the mixture to cure. Suitable mixing techniques include the use of a Ross PD Mixer (Charles Ross), Myers mixer, FlackTek Speedmixer, butterfly mixer and the like. Various components of the composition could also be mixed using a continuous process such as twin-screw extrusion. Various streams could be fed separately to an extruder or premixed in various combinations to form the blocked isocyanate composition and the isocyanate-reactive component. Such a process could be suitable for large volume manufacturing.

Prior to combination to form a thermally conductive composition, the isocyanate component and/or the isocyanate-reactive component may have a squeeze force of 200 N or less, 180 N or less, or 150 N or less. The isocyanate component and/or the isocyanate-reactive component may have a squeeze force in the range of 35 N to 250 N, 50 N to 150 N, or 60 N to 150 N.

Thermally conductive compositions may include an isocyanate component and/or isocyanate-reactive component that exhibit storage stability, characterized as a minimal viscosity or squeeze force increase over time until combination for future use. Thermally conductive compositions may include an isocyanate component and/or isocyanate-reactive component that have a viscosity, as determined by parallel plate rheometer, of less than 200 Pa·s at 1 sec⁻¹, less than 300 Pa·s at 1 sec⁻¹, or less than 350 Pa·s at 1 sec⁻¹. In some embodiments, the blocked isocyanate prepolymer composition and the amine composition may exhibit a viscosity change of <50% over 3 days, or <20% after heating at 60° C. over 7 days.

The isocyanate-reactive component and the isocyanate component can be combined such that the molar ratio of blocked isocyanate groups to amine reactive groups is in the ranges of 0.90:1.1 to 1.1:0.9, such as 0.90:1.1, 0.95:1.05, 0.97:1.03, or 1:1. At the same time, the volume ratio of the isocyanate-reactive component to the isocyanate component in the curable composition may be controlled within the range between 0.90:1.1 from 0.95:1.05, from 0.97:1.03, or at the ratio of 1:1.

The mixture of isocyanate component and isocyanate-reactive component may be cured at a temperature from 0° C. to 60° C., 10° C. to 50° C., 15° C. to 45° C., or 18° C. to 35° C. (e.g., RT). The cured thermally conductive composition may have a range of hardness as determined by ASTM D-2240-15 in a range of 40 to 90 Shore OO, 50 to 85 Shore OO, or 60 to 80 Shore OO.

Cured thermally conductive compositions may have a thermal conductivity >1.5 W/m·K, >2.0 W/m·K, >2.5 W/m·K, or >2.9, W/m·K, or <50 W/m·K. In some embodiments, cured thermally conductive compositions may have a density of 1 μm/cc to 4 μm/cc, 1.5 to 3.5 μm/cc, or 1.8 to 3.1 μm/cc.

Thermally conductive compositions disclosed herein may be useful as a gap filler for energy storage devices and in electronic vehicle battery thermal management. In some cases, the compositions may include gap fillers and pastes that are applied between a heat source and a heat sink to provide a thermally conductive interface, such as between a battery module and a cooling plate. Manual or automatic dispensing tools can be used to apply thermally conductive compositions directly to the target surface to minimize waste. In an embodiment, a thermally conductive composition may be prepared by combining an isocyanate component and an isocyanate-reactive component and applying to a cooling plate or heat sink an automated mix-meter-dispense system, followed by installation of a battery cell, module or pack, or other heat source.

Additionally, thermally conductive compositions may be used to form pre-cured articles such as thermal interface gap pads. In one example, pre-cured articles may be formed by curing a thermally conductive compositions at a desired thickness, cutting the article to a desired shape, and then compressed to fix in place as needed. In some cases, cured articles may also help reduce vibration stress for shock dampening.

### Examples

The following examples are provided to illustrate the embodiments of the invention, but are not intended to limit the scope thereof. All parts and percentages are by weight unless otherwise indicated. Table 1 lists the materials used in the following examples:

TABLE 1
Component chemicals used in the examples

| Component | Description |
|---|---|
| Blocked | TDI and Voranol ™-2000 LM (2000 Da MW polypropylene oxide |
| Prepolymer-1 | containing polyol with a functionality of 2) based blocked isocyanate |
| | prepolymer with 7.8% NCO before blocking with cardanol |
| Blocked | TDI and Voranol ™-2000 LM (2000 Da MW polypropylene oxide |
| Prepolymer-2 | containing polyol with a functionality of 2) based blocked isocyanate |
| | prepolymer with 12% NCO before blocking with cardanol |
| Amine-1 | Triamine based on polypropylene glycol backbone with a molecular weight |
| | of 3000 |
| Amine-2 | Triamine based on polypropylene glycol backbone with a molecular weight |
| | of 440 |
| Bimodal ATH | Hydrophobically surface modified bimodal Aluminum trihydrate (ATH) |
| Filler | with a D10 of 0.5 microns, D50 of 8 microns and D90 of 80 microns |
| Comp. Filler-1 | Zinc oxide filler, D50 <1 micron |
| Comp. Filler-2 | ATH Filler with D50 of 6 microns |
| Comp. Filler-3 | ATH filler with D50 of 12 microns |
| Comp. Filler-4 | ATH filler with D50 of 45 microns |
| Inv. Filler-1 | Alumina filler with D50 of 3 microns |
| Inv. Filler-2 | Alumina filler with D50 of 5 microns |
| Inv. Filler-3 | Alumina filler with D50 of 9.3 microns |
| Inv. Filler-4 | Alumina filler with D50 of 10 microns |
| Inv. Filler-5 | Alumina filler with D50 of 20 microns |
| Inv. Filler-6 | Alumina filler with D50 of 46 microns |
| Inv. Filler-7 | Alumina filler with D50 of 70 microns |
| Plasticizer-1 | Methyl ester derivative of Soybean oil |
| Plasticizer-1 | Bis(2-ethylhexyl) adipate |
| Catalyst-1 | Diazabicyclo[5.4.0]undec-7-ene |
| Catalyst-2 | N,N,N-tris-(3-Dimethylaminopropyl)amine |
| Dispersion | Hyperbranched polyester containing amine groups sterically protected by |
| Additive | polyester side chains. |
| Silane Treating | Hexadecyltrimethoxysilane |
| Agent | |

Sample formulations were prepared by mixing individual components in a high-speed mixer. Part A and Part B of each formulation were prepared separately. For curing two-part systems, Part A and Part B were mixed in 1:1 weight ratio and mixed using a high-speed mixer. Samples were allowed to cure at ambient conditions.

Squeeze force was measured using a texture analyzer equipped with a 50 kg load cell. After dispensing the gap filler onto a flat heavy-duty aluminum substrate, an acrylic probe with a diameter of 40 mm was lowered to sandwich the test material against the flat substrate to achieve a standard 5.0 mm gap thickness. Any excess overflow material was trimmed away with a flat-edge spatula. After trimming, the test started and the probe moved to a final thickness of 0.3 mm, at a rate of 1.0 mm/sec while the force was recorded. The specific force value recorded at the gap of 0.5 mm is reported as the “squeeze force”. Squeeze force <150N is desired.

The thermal conductivity was measured using the Hot Disk Thermal Constants Analyzer (TPS 2500S, Thermtest Instruments, Canada) per ISO 22007-2. All measurements are completed with a thermal probe using a double-sided measurement with two-6 mm cups, at 150 W heating power and 5 s measurement time.

Viscosity was measured with TA instruments DHR-2 rheometer equipped with a Peltier bottom plate and 25 mm parallel plate fixture at 0.45 mm gap.

Density was measured on the cured articles per ASTM D 792.

Hardness was measured using a Shore OO durometer per ASTM D2240.

Results are summarized in Tables 2-4, where samples designated “C” indicate comparative samples, and “I” indicating inventive samples in accordance with this disclosure.

TABLE 2
Comparative sample compositions and properties

| | C1 | C2 | C3 | C4 | C5 |
|---|---|---|---|---|---|
| | B-Side | B-Side | B-Side | B-Side | B-Side |
| Amine-1 | 2.5 | 2.5 | 2.5 | 2.5 | 2.5 |
| Plasticizer | 15.5 | 15.67 | 15.67 | 15.27 | 15.67 |
| Catalyst | — | 0.03 | — | 0.03 | 0.03 |
| Bimodal ATH Filler | 182 | 151.8 | 151.8 | 152.2 | 151.8 |
| Comp. Filler-1 | — | 30 | — | — | — |
| Comp. Filler-2 | — | — | 30 | — | — |
| Comp. Filler-3 | — | — | — | 30 | — |
| Comp. Filler-4 | — | — | — | — | 30 |
| Total | 200 | 200 | 200 | 200 | 200 |
| Squeeze force [N] | 260 | >400 | 343 | 302 | 211 |
| Thermal Conductivity | 3.13 | 3.26 | — | 3.14 | 2.98 |
| [W/m · K] | | | | | |

TABLE 3
Inventive sample compositions and properties

| | I1 | I2 | I3 | I4 |
|---|---|---|---|---|
| | B-Side | B-Side | B-Side | B-Side |
| Amine-1 | 2.5 | 2.5 | 2.5 | 2.5 |
| Plasticizer-1 | 15.67 | 15.27 | 15.67 | 15.67 |
| Catalyst-1 | 0.03 | 0.03 | 0.03 | 0.03 |
| Bimodal ATH Filler | 151.8 | 152.2 | 151.8 | 152 |
| Inv. Filler-1 | 30 | — | — | — |
| Inv. Filler-2 | — | 30 | — | — |
| Inv. Filler-3 | — | — | 30 | — |
| Inv. Filler-4 | — | — | — | 30.8 |
| Total | 200 | 200 | 200 | 200 |
| Squeeze force [N] | 132 | 128 | 92 | 108 |
| Thermal Conductivity | 3.03 | 2.91 | 2.96 | 3.13 |
| [W/m · K] | | | | |

TABLE 4
Inventive sample compositions and properties

| | I5 | I6 | I7 |
|---|---|---|---|
| | B-Side | B-Side | B-Side |
| Amine-1 | 2.5 | 2.5 | 2.5 |
| Plasticizer-1 | 15.67 | 15.67 | 15.67 |
| Catalyst-1 | 0.03 | — | 0.03 |
| Bimodal ATH Filler | 151.8 | 150 | 151.8 |
| Inv. Filler-5 | 30 | — | — |
| Inv. Filler-6 | — | 31.8 | — |
| Inv. Filler-7 | — | — | 30 |
| Total | 200 | 200 | 200 |
| Squeeze force [N] | 86 | 97 | 94 |
| Thermal Conductivity | 3.06 | 2.96 | 2.93 |
| [W/m · K] | | | |

As indicated in the results, C1 including only bimodal ATH filler (corresponding to a first and second filler) exhibited relatively high squeeze force. C2 including zinc oxide as an additional filler, produced a thick sample having a squeeze force >400 N. Samples C3 and C4 containing a second filler having an average particle size of <15 micron ATH as second filler. Similar results were obtained for C5 containing a second filler having an average particle size >20 micron ATH filler. In contrast, inventive samples containing 5-100 micron Alumina as a filler exhibited low squeeze force <150 N and high thermal conductivity.

The example shown below in Table 4 includes two-part curable compositions with the filler combination disclosed above. Both Part A and part B had a low squeeze force and high thermal conductivity. Part A and B could be mixed to form a cured part with the hardness range of 75-85 Shore OO within 7 days. Cured part also had a high thermal conductivity and a low density of 2.1-2.2 gm/cc.

TABLE 4
Inventive sample compositions and properties

| | I8 | | I9 | |
|---|---|---|---|---|
| | | B-Side | | B-Side |
| | A-Side | (I4) | A-Side | (I3) |
| Blocked prepolymer-1 | 2 | — | 2 | — |
| Amine-1 | — | 2.5 | — | 2.5 |
| Plasticizer-1 | 14.72 | 14.27 | 15.72 | 15.27 |
| Bimodal ATH Filler | 152 | 152 | 152.2 | 152.2 |
| Inv. Filler-3 | — | — | 30 | 30 |
| Inv. Filler-4 | 31.2 | 31.2 | — | — |
| Blue Colorant | 0.08 | — | 0.08 | — |
| Catalyst | — | 0.03 | — | 0.03 |
| Total | 200.00 | 200.00 | 200.00 | 200.00 |
| Squeeze force [N] | 96 | 108 | 83 | 95 |
| Thermal Conductivity [W/m · K] | 2.957 | 3.120 | 2.967 | 2.94 |

Combined Composition Properties

| | | |
|---|---|---|
| Thermal conductivity [W/m · K] | 3.048 | 2.998 |
| Hardness-Shore OO-7 days | 77 | 83 |
| Density [g/cc] | 2.17 | 2.18 |

The example shown below in Table 5 demonstrates that compositions with low viscosity, low squeeze force and high thermal conductivity could be obtained with the addition of a silane and dispersion additive. Further, the compositions had storage stability as indicated by negligible separation of liquid phase from the paste based on visual observation. Composition also cured rapidly within 5 days to form a solid with a hardness of 75 Shore OO.

TABLE 5
Inventive sample compositions and properties

| | I10 | |
|---|---|---|
| | A-side | B-side |
| Prepolymer-2 | 5 | — |
| Amine-2 | — | 0.88 |
| Amine-1 | | 2.00 |
| Plasticizer-1 | 5 | 5.41 |
| Plasticizer-2 | 4.9 | 7.31 |
| Catalyst-2 | — | 1 |
| Dispersion additive | — | 0.4 |
| Silane Treating Agent | 4 | 2 |
| Blue Colorant | 0.1 | — |
| Bimodal ATH Filler | 121 | 121 |
| Inv. Filler-3 | 60 | 60 |
| Total | 200 | 200 |
| Viscosity [Pa · s] at 1 sec⁻¹ | 62.4 | 56.80 |
| Viscosity [Pa · s] at 10 sec⁻¹ | 37.3 | 24.5 |
| Thermal conductivity [W/m · K] | 2.804 | 2.846 |
| Squeeze force [N] | 59 | 35 |
| Liquid separation | Non measurable | Non measurable |

Combined composition properties

| | |
|---|---|
| Hardness - Shore OO at 5 days | 75 |
| Thermal Conductivity [W/m · K] | 2.931 |

While the foregoing is directed to exemplary embodiments, other and further embodiments may be devised without departing from the basic scope thereof, and the scope thereof is determined by the claims that follow.

1. A thermally conductive composition, comprising:
a polymer matrix; and
a polymodal filler composition at a percent by weight (wt %) of the thermally conductive composition in a range of 60 wt % to 95 wt %, comprising a first thermally conductive filler of aluminum trihydrate (ATH) having a D50 particle size in the range of 0.1 μm to 10 μm, a second thermally conductive filler of ATH having a D50 in the range of 10 μm to 100 μm, wherein the first thermally conductive filler and the second thermally conductive filler are present at a percent by weight of the polymodal filler composition (wt %) in a range of 40 wt % to 90 wt %; and a third thermally conductive filler of alumina having a D50 in the range of 5 μm to 100 μm at a percent by weight of 10 wt % to 60 wt %.

2. The composition of claim 1, wherein the polymeric binder is prepared by a reaction of
an isocyanate component comprising a blocked isocyanate prepolymer; and
an isocyanate-reactive component comprising: one or more polyetheramines, and one or more catalysts selected from a group consisting of carboxylate salts, tertiary amines, amidines, guanidines, and diazabicyclo compounds.

3. The composition of claim 1, wherein the thermally conductive composition has a thermal conductivity of 1.5 W/m·K or greater.

4. The composition of claim 1, wherein the isocyanate component and the isocyanate-reactive component each have a squeeze force of less than 150 N.

5. The composition of claim 1, wherein the isocyanate component and the isocyanate-reactive component each have a viscosity of less than 300 Pa·s at 1 sec⁻¹ measured using a parallel plate rheometer.

6. Composition of claim 1, wherein the first and second filler is a combination of ATH with D₁₀ in the range of 0.1 to 10 microns, D₅₀ in the range of 5 to 50 microns, and D₉₀ in the range of 50 to 200 microns.

7. The composition of claim 1, wherein one or more of the first thermally conductive filler, second thermally conductive filler, or third thermally conductive filler are hydrophobically modified with a treating agent.

8. The composition of claim 1, wherein the first thermally conductive filler and second thermally conductive filler are pre-treated with a silane treating agent.

9. The composition of claim 1, wherein a silane treating agent is added to one or more of the isocyanate component and the isocyanate-reactive component.

10. The composition of claim 1, wherein the isocyanate-reactive component comprises a hyperbranched polyester containing amine groups sterically protected by polyester side chains.

11. A thermally conductive gap filler prepared by combining the isocyanate component and the isocyanate-reactive component, and curing the resulting thermally conductive composition of claim 1.

12. A method of using a thermally conductive composition, comprising:
combining an isocyanate component comprising a blocked isocyanate prepolymer and an isocyanate-reactive component comprising one or more polyetheramines to form the thermally conductive composition,
wherein the isocyanate component and/or the isocyanate-reactive component comprise a polymodal filler composition at a percent by weight (wt %) of the thermally conductive composition in a range of 60 wt % to 95 wt %, the polymodal filler composition comprising a first thermally conductive filler of aluminum trihydrate (ATH) having a D50 particle size in the range of 0.1 μm to 10 μm, a second thermally conductive filler of ATH having a D50 in the range of 10 μm to 100 μm, wherein the first thermally conductive filler and the second thermally conductive filler are present at a percent by weight of the polymodal filler composition (wt %) in a range of 40 wt % to 90 wt %; and a third thermally conductive filler of alumina having a D50 in the range of 5 μm to 100 μm at a percent by weight of 10 wt % to 60 wt %; and
emplacing the thermally conductive composition between a heat source and a heat sink in an EV battery.
